(19) United States
(12) Patent Application Publication
(10) Pub. No.: US 2009/0151852 A1
(43) Pub. Date: Jun. 18, 2009

(54) METHOD FOR PRODUCING A MOLDING MADE OF A COMPOSITE MATERIAL

(76) Inventor: Geerardus Hubertus Joannes Jozeph Roebroeks, Den Bommel (NL)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 12/088,627

(22) PCT Filed: Sep. 25, 2006
(86) PCT No.: PCT/NL2006/050236

§ 371 Date: Aug. 25, 2008

(30) Foreign Application Priority Data
Sep. 29, 2005 (NL) 1030066

(51) Int. Cl. B32B 37/00

(52) U.S. Cl. 156/64; 156/60; 156/580; 156/349; 156/378

(57) ABSTRACT

The invention relates to a method for producing a molding with tapered thickness made of a laminate comprising at least one metal layer and one fiber-reinforced plastic layer connected thereto. The method at least comprises partly pressurizing the laminate at least in the direction of thickness using a pressurizing means, provided that deformation in the plane of the laminate is substantially unimpeded. The invention also relates to a device for implementing the method.

The invention relates to a method for producing a molding made of a laminate comprising at least one metal layer and one fiber-reinforced plastic layer connected thereto. The invention also relates to a device for producing the molding. The invention relates in particular to a method for producing a molding made of such a laminate with a tapered thickness.

Moldings made of a laminate comprising at least one metal layer and one fiber-reinforced plastic layer connected thereto (hereinafter referred to as a fiber metal laminate or laminate for short) are increasingly used in industries such as the transportation industry, for example in cars, trains, aircraft and spacecraft. Such fiber metal laminates can for example be used as a stiffener for wings, fuselage and tail panels and/or other skin panels for aircraft. Such a stiffener is in practice affixed by means of adhesion over almost the entire length of the part to be reinforced, for example over almost the entire wing span, and can for example provide improved fatigue resistance of the wing. In order to exploit this effect, the actual molding made of fiber metal laminate must obviously have good mechanical properties, more particularly fatigue properties. In addition, moldings such as the stiffener referred to above can have a tapered thickness of a few millimeters over its length, for example enabling the molding to be effectively fitted onto another part to be stiffened. Such a tapered thickness of the fiber metal laminate is for example obtainable by discontinuing at least one metal layer and/or fiber-reinforced plastic layer at a number of locations.

Although fiber metal laminates are known per se as fatigue-resistant materials, there is as yet no method in the prior art that can be applied on an industrial scale for producing a molding made of such a fiber metal laminate, in particular a molding with a tapered thickness. The existing method is time-consuming and furthermore does not generally lead to the desired mechanical properties.

The object of this invention is to provide a method for producing a molding made of a fiber metal laminate, in particular with a tapered thickness, that inter alia does not have the above disadvantages.

The method according to the invention is thereto characterized as referred to in claim 1. More particularly, the method at least comprises partly pressurizing the laminate, at least in the direction of thickness, using a pressurizing means, provided that deformation in the plane of the laminate is substantially unimpeded. Pressurizing sheet material in the direction of thickness, for example using compression presses, is a method known per se for producing moldings on an industrial scale. According to the present invention, it now turned out that if this method is applied to a fiber metal laminate in such a way that deformation in the plane of the laminate can take place substantially unimpeded, a molding is obtainable with a tapered thickness and having mechanical properties—in particular fatigue resistance—that are at least equivalent to the molding produced according to the known method. It is important to let the laminate deform in a substantially unimpeded fashion in the plane of the laminate according to the inventive method, as this makes it possible at least partly to achieve an elongation in this plane. It turned out that this at least local elongation, together with the exerted compressive forces, evidently has a favorable effect on the mechanical properties of the molding. More particularly, it turned out that the fatigue resistance as well as the bond between the fiber-reinforced plastic layers and metal layers are further improved as a result. When reference is made in this application to letting the laminate deform substantially unimpeded in the plane of the laminate, it is understood that the laminate is not or is barely obstructed at its edges. It should be noted that at locations on the laminate that are further away from the free edges, it is possible for deformations to be hindered in the plane of the laminate by adjacent material and/or by friction with pressurizing means.

In a preferred embodiment, the method according to the invention is characterized in that the exerted compressive force is at least large enough to elongate the laminate in a longitudinal direction, such elongation being larger than the elastic elongation of the metal layers and less than the elongation at break of the fiber-reinforced plastic layer.

By setting the exerted compressive force at a sufficiently high level, the deformations in the plane of the laminate are of such a size that the imposed elongation in a longitudinal direction exceeds the plasticity limit of the metal, causing the metal layer or layers to permanently deform, without leading to failure of the fiber-reinforced layer or layers. By extending the laminate in the longitudinal direction, a particularly favorable state of stress is created, whereby a compressive stress prevails on average in the metal layers and a tensile stress on average in the fiber-reinforced plastic layers throughout the laminate in unloaded state. The level of the compressive force to be exerted will depend inter alia on the properties of the metal layers and fiber-reinforced plastic layers and can easily be determined by the person skilled in the art. When reference is made in this application to the longitudinal direction, it is understood to be the direction in the plane of the laminate in which it is extended or pre-stressed. The longitudinal direction can easily be ascertained by the person skilled in the art, in that it will depend inter alia on the geometry of the pressurizing means.

Particularly favorable mechanical properties are obtained by a preferred embodiment of the method, whereby the laminate is pressurized in its direction of thickness, with the compressive force being such that the elongation imposed on the laminate in the longitudinal direction is between 0.1 and 2 percent. More preferably, this elongation is between 0.2 and 1.4 percent, and more particularly between 0.3 and 0.7 percent. The average elongation imposed on the laminate in the method according to the invention can be estimated by the person skilled in the art as shown in more detail below in this application.

According to the inventive method, the laminate can be advantageously formed into a molding using a device comprising at least one pressurizing means for partly pressurizing the laminate, at least in the direction of thickness, provided that deformation in the plane of the laminate is substantially unimpeded. For instance, it is possible to place a sheet made of fiber metal laminate between the pressure plates of a compression press, whereby the pressure plates are provided with a friction-reducing means, such as a wax. By keeping the edges of the laminate sheet free—and thus not restraining the sheet—the sheet is compressed when the compression press closes until a pre-set displacement of the pressure plates is achieved. The compression leads to an almost isotropic elongation in the plane of the sheet. In this embodiment of the method and device, the laminate is therefore extended in at least two principal directions.

In an improved preferred embodiment, a device according to the invention comprises a pulling device enabling the laminate to be continuously fed, and the pressurizing means comprises a rolling mill with a lower and upper pressurizing means between which the laminate can be fed in a continuous fashion in the form of a continuous sheet and pressurized. If desired, the device is also provided with means for keeping the distance between the pressurizing means and/or the compressive force at the level of the contact surface with the laminate at a desired value. By using such a device, the fiber metal laminate is fed in a continuous fashion in the form of a continuous sheet and pressurized according to a preferred method. In this way, the thickness of the molding can be set by keeping the distance between the pressurizing means or the compressive force at the level of the contact surface with the laminate at a desired value. A method is thus provided that can be applied on an industrial scale, whereby moldings made of fiber metal laminate having a tapering thickness by applying discontinued layers are preferably obtained, such moldings also comprising a pre-stressed fibrous laminate. Pressurizing means suitable for use in the device according to the invention comprise for example at least one set of cylindrical rollers arranged one above the other or across from each other between which the laminate can be guided. If desired, the rollers can be of a rotating design or they can be driven. In this latter preferred embodiment, no separate pulling device is required, because the rollers can guide the laminate through the device, thus fulfilling the function of a pulling device. The means for keeping the distance between the pressurizing means at the level of the contact surface with the laminate at a desired value can for example be mechanical in nature. In this way it is possible to set the pressurizing means at a fixed adjustable distance from each other. It is also possible to use displacement sensors, if desired integrated within a control mechanism. It should be noted that there are various options in this respect available to the person skilled in the art and that the invention is not restricted to any one of these solutions.

The method and device according to the invention are particularly suitable for producing moldings with a thickness tapering along their length and/or depth, and in particular a gradually tapering thickness. A tapering thickness is hereby preferably achieved by terminating successive layers of the laminate in a stepwise fashion. If such a laminate is pre-stressed using the known method, this can lead to significant stress concentrations at the level of the end of the terminated layers, which has a disadvantageous effect on the fatigue properties of the molding. Furthermore, such a molding is more sensitive to delamination, whereby the layers can more easily separate from each other. A molding produced according to the inventive method surprisingly shows improved fatigue behavior, even if the molding comprises a fiber metal laminate with a tapering thickness obtained by terminating layers. A further advantage of the method according to the invention is that a substantially uniform extension (or pre-stressing) of the laminate can occur even with laminates with a tapering thickness. This is not possible with the known method whereby the laminate is subjected to tensile forces in its plane. The average tensile stress in thinner sections of the laminate will indeed be higher than the average tensile stress in the thicker sections. Although each layer of the fiber metal laminate can in principle be discontinued to give the laminate a tapering thickness, it is advantageous not to discontinue the outer layers and to only terminate inner layers locally. Such a configuration of the laminate with a tapering thickness shows no sudden jumps in thickness, which in turn enables the rolling operation to run in a controlled fashion even at locations with discontinued layers. The molding obtained using the present preferred method is also advantageous in that the metal layers situated on the outside are substantially uninterrupted, thus effectively protecting the reinforcing fibers from ambient influences.

To provide a molding with an at least partly tapering thickness whereby the properties—in particular pre-stress—still remain relatively constant over the length thereof, the fiber metal laminate in a preferred embodiment is fed in a continuous fashion in the form of a continuous sheet and pressurized, whereby the compressive force exerted on the laminate by the pressurizing means is kept at a predefined value. To this end, the device according to the invention is provided with means to enable the compressive force exerted on the laminate by the pressurizing means to be kept at a predefined value. As the laminate is guided through the pressurizing means, the force exerted on the laminate by the pressurizing means is measured in a continuous fashion. By incorporating the force measurement in a control mechanism and maintaining a substantially constant force, the distance between the pressurizing means at the level of the contact surface with the laminate is automatically adjusted to possible variations therein. Variations in thickness can be caused by an intentionally applied tapered thickness. However, a variation in the laminate's thickness can also be created by variations in thickness within the relevant material specifications that unavoidably occur in the layers of the laminate. Means that are able to maintain a predefined compressive force are known per se and can for example comprise force sensors incorporated in a control mechanism if desired. It should be noted that there are various options in this respect available to the person skilled in the art and that the invention is not restricted to any one of these solutions.

In a preferred embodiment of the method, the displacement velocity of the laminate is measured before and after the location where the laminate is pressurized. To this end, the device according to the invention is provided with means that can measure the displacement velocity before and after the rolling mill. A preferred device thus comprises a wheel that can roll along with the laminate, the rotational speed of which can be determined. By also incorporating a control circuit in the device that can set the compressive force exerted on the laminate depending on the ratio of the displacement velocities measured after and before the rolling mill, it is possible to impose an effectively controlled elongation on the laminate, all of which is almost independent of variations in thickness in the laminate.

In a further preferred embodiment of the method, the thickness of the laminate is measured before, at the location where and/or after the laminate is guided through the rolling mill. To this end, the device is provided with one or more thickness meters known per se that are preferably incorporated in a control circuit for the compressive force. If desired, a combined measuring instrument can be applied for measuring the thickness and displacement velocity. In a possible embodiment, the distance between the rollers can for example be measured. A thickness measurement prior to rolling is advantageous in that it is possible to determine where a tapered thickness in the laminate is located. By ascertaining this point prior to rolling, it is possible to accurately determine when the tapered thickness will be located between the rollers based on the speed at which the laminate passes through the device. While the tapered thickness is being rolled, the compressive force to which the laminate is subjected is then preferably adjusted. Depending on the properties of the input laminate and the desired properties of the molding produced according to the method, it is possible to keep the compressive force at a constant value or to increase or just decrease it, while the tapered thickness is being rolled.

The fiber metal laminate can in principle be pressurized at any temperature, and if desired at an increased temperature, for example for fiber metal laminates with fiber-reinforced thermoplastic polymer layers. The device according to the invention therefore preferably comprises heating means. The level of the desired temperature depends inter alia on the type of fiber-reinforced plastic and/or metal applied in the laminate, but can also for example depend on the form of the molding to be produced. Suitable temperatures can vary from temperatures below room temperature to hundreds of ° C. In this respect the location where the temperature is increased is irrelevant. It is therefore possible to bring the laminate up to the suitable temperature before, during and/or after it is pressurized. A suitable method for bringing the laminate up to temperature involves for example heating the laminate by means of contact heat by placing it between hot plates or guiding it through heated roller components. It is also possible to bring the laminate up to temperature using radiant heat, for example infrared (IR), or using convection heat.

In a particularly suitable embodiment of the method according to the invention, the laminate has a temperature of between 0 and 80° C. when it is pressurized. This temperature is more preferably between 10 and 40° C.

Fiber metal laminates suitable for the method according to the invention comprise one or more metal layers having a layer thickness that is preferably less than 1 mm, more preferably between 0.1 and 0.8 mm, and most preferably between 0.3 and 0.5 mm. The layers are preferably of almost the same thickness, although this is not a prerequisite. Applying thinner metal sheets in the laminate generally leads to better mechanical properties, but to date this option is not frequently applied on account of higher costs. The method according to the invention has the additional advantage that it makes it possible to apply more expensive, and thus better, laminates for a comparable cost price of the molding.

Fiber metal laminates may be obtained by connecting a number of metal layers and intermediary fiber-reinforced plastic layers to each other by means of heating under pressure and then cooling them. Fiber metal laminates have good specific mechanical properties (properties per unit of density). Metals that are particularly suitable to use include light metals, in particular aluminum alloys, such as aluminum copper and/or aluminum zinc alloys, or titanium alloys. In other respects, the method according to the invention is not restricted to processing laminates using these metals, so that if desired steel can be used for example or another suitable structural metal.

The fiber-reinforced plastics applied in the fiber metal laminates are light and strong and comprise reinforcing fibers embedded in a polymer. The polymer also acts as an adhesive between the various layers. Reinforcing fibers that are suitable for use include for example glass fibers, carbon fibers, metal fibers, drawn thermoplastic polymer fibers, such as aramid fibers, PBO fibers (Zylon®), M5® fibers, and ultrahigh molecular weight polyethylene or polypropylene fibers, as well as natural fibers such as flax, wood and hemp fibers, and/or combinations of the above fibers. It is also possible to use commingled and/or intermingled rovings. Such rovings comprise a reinforcing fiber and a thermoplastic polymer in fiber form. Examples of suitable matrix materials for the reinforcing fibers are thermoplastic polymers such as polyamides, polyimides, polyethersulphones, polyetheretherketone, polyurethane, polyethylene, polypropylene, polyphenylene sulphides (PPS), polyamide-imides, acrylonitrile butadiene styrene (ABS), styrene/maleic anhydride (SMA), polycarbonate, polyphenylene oxide blend (PPO), thermoplastic polyesters such as polyethylene terephthalate, polybutylene terephthalate, as well as mixtures and copolymers of one or more of the above polymers, and thermosetting polymers such as epoxies, unsaturated polyester resins, melamine/formaldehyde resins, phenol/formaldehyde resins, polyurethane, etcetera.

In a preferred embodiment of the method, the fiber-reinforced plastic substantially comprises continuous fibers that extend in two almost orthogonal directions (so called isotropic woven fabric). In another preferred embodiment, the fiber-reinforced plastic substantially comprises continuous fibers that mainly extend in one direction (so called UD woven fabric). It is advantageous to use the fiber-reinforced plastic in the form of a pre-impregnated semi-finished product. Such a “prepreg” shows generally good mechanical properties after curing thereof, among other reasons because the fibers have already been wetted in advance by the matrix polymer.

A fiber metal laminate will generally be formed by a number of metal sheets, for example three, four, five or six, between each of which fiber-reinforced plastic layers have been applied. Depending on the intended use and requirements set, the optimum number of metal sheets can easily be determined by the person skilled in the art. The total number of metal sheets will generally not exceed 30, although the method according to the invention is not restricted to forming laminates with a maximum number of metal layers such as this.

It is advantageous if the fiber metal laminate applied in the method according to the invention contains a fiber-reinforced plastic with substantially continuous fibers that mainly extend in the longitudinal direction of the laminate. A particularly suitable material for the reinforcing part comprises a laminate of at least two metal layers and an intermediary fiber-reinforced plastic layer. Such a material is known to persons skilled in the art under the trade name Arall® (with polyaramide fibers) or Glare® (with glass fibers). This material is preferably used in a pre-stressed form, whereby the fibers of the intermediary fiber-reinforced plastic layer are on average subjected to a tensile stress and the metal layers to a compressive stress. According to the invention, it is now possible to produce such a pre-stressed laminate in a continuous fashion, and this is furthermore possible for laminates with a tapered thickness.

Further features of the invention will emerge from the accompanying figures, in which:

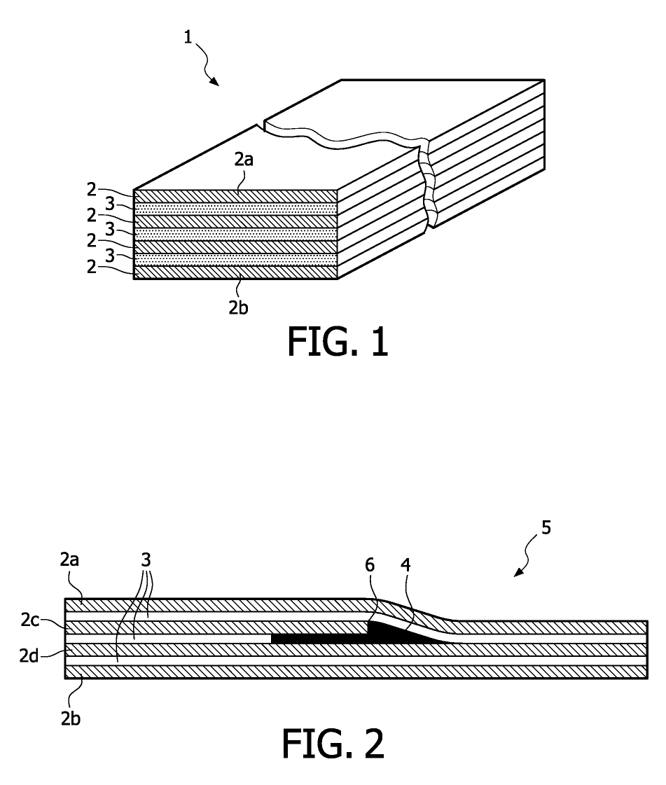

FIG. 1 schematically shows a fiber metal laminate in perspective that can be applied in the method according to the invention;

FIG. 2 schematically shows a side view of a laminate with tapering thickness that can be applied in the method according to the invention;

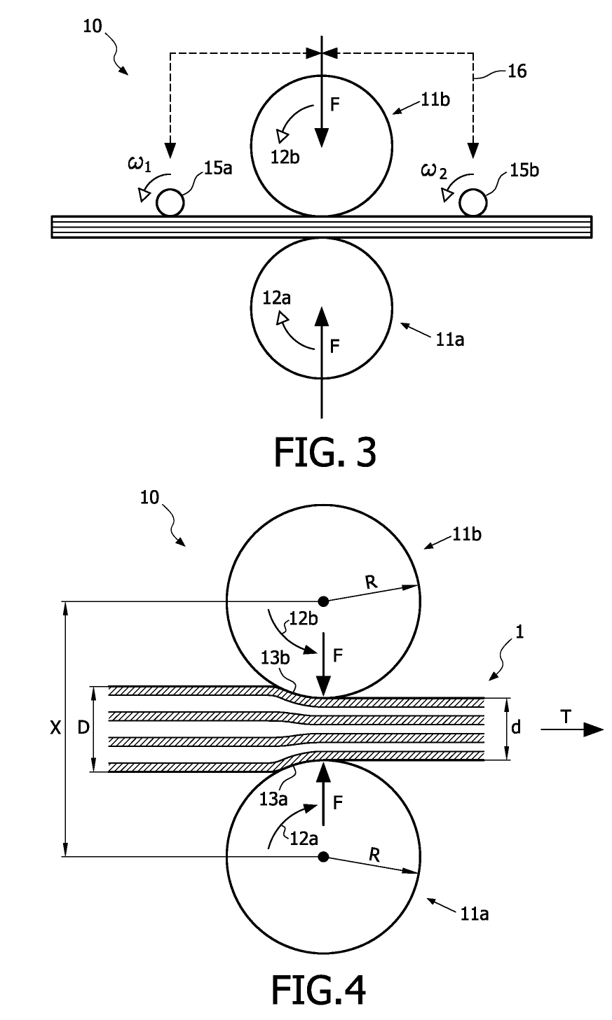

FIG. 3 schematically shows a side view of a control mechanism for the compressive force;

FIG. 4 schematically shows a section of an embodiment of a device according to the invention.

With reference to FIG. 4, a preferred embodiment of the device according to the invention comprises a pulling device (11a, 11b) enabling a fiber metal laminate 1 to be continuously fed through a pressurizing means 10. Pressurizing means 10 is in the form of a rolling mill with a lower pressurizing means 11a and an upper pressurizing means 11b, between which the laminate 1 is fed in a continuous fashion as a continuous sheet. The tensile force T is produced in this embodiment by driving the set of rollers (11a, 11b) in the indicated directions of rotation (12a, 12b), whereby the laminate 1 is carried along by exerting a friction force thereupon. The rollers 11 are positioned at a distance X from each other, such that they subject at least that part of the laminate 1 that is guided between the rollers 11 to a compressive force F directed almost in the direction of thickness while the laminate is being guided through. Laminate 1 passes from input thickness D to output thickness d by means of compressive force F. At the same time, the laminate 1 is extended in its plane (in this case in the direction of tensile force T). The elongation thus imposed on the laminate 1 can easily be set by the person skilled in the art, inter alia by suitably selecting the intermediate distance X and radius R of the two rollers 11. If desired, it is possible to select different radii for the roller set. Although not shown in FIG. 4, it is also possible to arrange a number of rollers 11 one after the other, so that the change in thickness and extension proceeds in a phased fashion. The device 10 is also provided with means 15 to measure the displacement velocity before and after the rolling mill 11, as shown schematically in FIG. 3. To this end, the device is provided with wheels (15a, 15b) that can roll along with the laminate, the rotational speed ω of which can be measured in a continuous fashion. A control circuit 16 (shown schematically by the dotted line) is also incorporated, said circuit being able to continuously set the compressive force F exerted on the laminate 1, depending on the measured rotational speeds ω₂ and ω₁, and more particularly the ratio ω₂/ω₁ of the displacement velocities measured after and before the rolling mill 11. This imposes a well-controlled elongation on the laminate 1, which is almost independent of variations in thickness in the laminate 1.

With reference to FIG. 1, a laminate 1 that is particularly suitable for use in the method according to the invention comprises four metal sheets 2 that are attached to each other by means of intermediary fiber-reinforced plastic layers 3. The outer sides of laminate 1 will generally be provided with two metal sheets 2a and 2b. These metal sheets protect the fiber-reinforced plastic layers 3 from external influences. FIG. 2 schematically shows a fiber metal laminate 1 with a thickness tapering in the longitudinal direction thereof. Although the thickness is shown to taper fairly abruptly, it should be noted that in practice the thickness can taper more gradually and smoothly than indicated in FIG. 2. As shown in FIG. 2, such a molding made of fiber metal laminate is obtained by terminating successive layers of the laminate in a stepwise fashion. In the laminate 1 shown, the metal layer 2c is discontinued locally, at which location the thickness tapers. Terminating an inner layer 2c, and not for example a layer 2a or 2b situated on the outside, prevents the end face 6 in use from being exposed to external effects, which is disadvantageous. To prevent the laminate 1 from further weakening unnecessarily at the location where the thickness tapers, an additional adhesive layer 4 is applied if desired. By rolling the output laminate 1 with tapered thickness thus obtained according to the invention under a compressive force controlled preferably by measuring the displacement velocity—as described above—a molding is obtained in the form of an almost uniformly pre-stressed (extended) fiber metal laminate.

The moldings obtained in the method according to the invention can be used in industrial applications as lightweight structural elements, such as for example in structures, buildings, vehicles and ships, whereby the molding has good mechanical properties, in particular resistance to fatigue.

1-22. (canceled)

23. A method for forming a laminate comprising:
providing a fiber metal laminate having at least one metal layer and at least one fiber-reinforced plastic layer connected thereto, wherein a thickness of the fiber metal laminate tapers in a longitudinal direction; and
pressurizing the fiber metal laminate at least in the direction of thickness such that a compressive force is exerted on the fiber metal laminate while allowing a deformation of the fiber metal laminate to occur umimpeded to result in a pre-stressed laminate,
wherein the pre-stressed laminate has an average compressive stress in the at least one metal layer and an average tensile stress in the at least one fiber-reinforced plastic layer in an unloaded state.

24. The method of claim 23 wherein the deformation of the fiber metal laminate is of such a size that an imposed elongation in the longitudinal direction of the fiber metal laminate exceeds a plasticity limit of the at least one metal layer resulting in a permanent deformation of the at least one metal layer without leading to failure of the at least one fiber-reinforced plastic layer.

25. The method of claim 23 wherein the thickness of the fiber metal laminate tapers by terminating successive layers of the fiber metal laminate in a stepwise fashion.

26. The method of claim 24 wherein the resulting permanent deformation of the at least one metal layer is such that the elongation of the fiber metal laminate in the longitudinal direction is between 0.2 and 1.4 percent.

27. The method of claim 26 wherein the resulting permanent deformation of the at least one metal layer is such that the elongation of the fiber metal laminate in the longitudinal direction is between 0.3 and 0.7 percent.

28. The method of claim 23 wherein the at least one metal layer includes an aluminum alloy.

29. The method of claim 23 wherein the at least one fiber-reinforced plastic layer includes reinforcing fibers embedded in a polymer matrix.

30. The method of claim 29 wherein the reinforcing fibers are selected from the group consisting of glass fibers, carbon fibers, metal fibers, drawn thermoplastic fibers, natural fibers and combinations thereof.

31. The method of claim 30 further comprising:
measuring the compressive force exerted on the fiber metal laminate;
measuring a separation distance between an upper pressurizing means and a lower pressuring means; and
adjusting the separation distance between the upper pressurizing means and the lower pressuring means such that the compressive force exerted on the fiber metal laminate is kept at a predefined value and contact with an upper and a lower surface of the fiber metal laminate is maintained.

32. The method of claim 23 further comprising:
measuring a pre-pressurized displacement velocity of the fiber metal laminate;
measuring a post-pressurized displacement velocity of the fiber metal laminate;
determining a ratio of the post-pressurized displacement velocity to the pre-pressurized displacement velocity; and
setting the compressive force exerted on the fiber metal laminate depending on the ratio determined,
wherein an effectively controlled elongation is imposed on the fiber metal laminate almost independent of variations in the thickness of the fiber metal laminate.

33. The method of claim 32 wherein the pre-pressurized displacement velocity and the post-pressurized displacement velocity are measured by measuring a rotational speed of a wheel rolling along with the fiber metal laminate.

34. The method of claim 23 further comprising:
measuring a pre-pressurized thickness of the fiber metal laminate;
measuring a pre-pressurized displacement velocity of the fiber metal laminate;
measuring the pre-pressurized thickness of the fiber metal laminate to determine where the tapered thickness of the fiber metal laminate is located;
measuring the pre-pressurized displacement velocity of the fiber metal laminate to determine when the tapered thickness will be located between an upper pressurizing means and a lower pressuring means; and
adjusting the compressive force exerted on the fiber metal laminate depending on when the tapered thickness is located between the upper pressurizing means and the lower pressuring means.

35. A device for producing a laminate comprising:
a pressurizing means for exerting pressure on a fiber metal laminate having a thickness that tapers in a longitudinal direction, the fiber metal laminate having at least one metal layer and at least one fiber-reinforced plastic layer connected thereto, wherein a compressive force is exerted on the fiber metal laminate while allowing a deformation of the fiber metal laminate to occur umimpeded to result in a pre-stressed laminate,
wherein the pre-stressed laminate has an average compressive stress in the at least one metal layer and an average tensile stress in the at least one fiber-reinforced plastic layer in an unloaded state.

36. The device of claim 35 wherein the pressurizing means includes an upper pressurizing means and a lower pressuring means and the fiber metal laminate is fed in a continuous fashion between the upper pressurizing means and the lower pressurizing means.

37. The device of claim 35 wherein the pressure exerted on the fiber metal laminate is at least in the direction of thickness and the compressive force exerted on the fiber metal laminate is at least large enough to elongate the fiber metal laminate in the longitudinal direction, wherein the elongation exceeds a plasticity limit of the at least one metal layer resulting in a permanent deformation of the at least one metal layer without leading to failure of the at least one fiber-reinforced plastic layer.

38. The device of claim 35 wherein the pressurizing means is a rolling mill having a set of cylindrical rollers.

39. The device of claim 36 further comprising:
means for measuring the compressive force exerted on the fiber metal laminate; and
means for measuring a separation distance between the upper pressurizing means and the lower pressuring means,
wherein the separation distance between the upper pressurizing means and the lower pressuring means is adjusted such that the compressive force exerted on the fiber metal laminate is kept at a predefined value and contact with the upper and the lower surface of the fiber metal laminate is maintained.

40. The device of claim 35 further comprising means for determining a ratio of a post-pressurized displacement velocity of the fiber metal laminate to a pre-pressurized displacement velocity of the fiber metal laminate, wherein the compressive force exerted on the fiber metal laminate is set depending on the ratio determined and the elongation imposed on the fiber metal laminate is effectively controlled almost independent of variations in the thickness of the fiber metal laminate.

41. The device of claim 36 further comprising:
means for measuring a pre-pressurized thickness of the fiber metal laminate to determine where the tapered thickness of the fiber metal laminate is located; and
means for measuring a pre-pressurized displacement velocity of the fiber metal laminate to determine when the tapered thickness will be located between the upper pressurizing means and the lower pressurizing means,
wherein the compressive force exerted on the fiber metal laminate may be adjusted depending on when the tapered thickness is located between the upper pressurizing means and the lower pressurizing means.

42. The device of claim 35 further comprising means for heating the fiber metal laminate to a desired temperature.
